(19) United States
(12) Patent Application Publication
(10) Pub. No.: US 2024/0244688 A1
(43) Pub. Date: Jul. 18, 2024

(54) METHODS AND SYSTEMS FOR SUBSCRIPTION SHARING IN A MULTI-SUBSCRIBER IDENTITY MODULE (MSIM) USER EQUIPMENT IN DUAL CONNECTIVITY MODE

(71) Applicant: QUALCOMM Incorporated, San Diego, CA (US)

(72) Inventors: Ansah Ahmed SHEIK, Hyderabad (IN); Daniel AMERGA, San Diego, CA (US); Peng HU, Beijing (CN)

(21) Appl. No.: 18/558,559

(22) PCT Filed: Jul. 31, 2021
(86) PCT No.: PCT/CN2021/109929

§ 371 Date: Nov. 2, 2023

(51) Int. Cl. H04W 76/15; H04W 36/08; H04W 68/02; H04W 84/04

(52) U.S. Cl. CPC H04W 76/15; H04W 36/08; H04W 68/02; H04W 84/042

(57) ABSTRACT

Various aspects of the present disclosure generally relate to wireless communication. In some aspects, a user equipment (UE) may detect that a radio access technology (RAT) of a first cell on which a first subscription of the UE is configured to camp is same as the RAT of a secondary cell group (SCG) on which a second subscription of the UE that is in a dual connectivity mode is configured to camp. In some instances, the UE may then trigger, in response to the detecting, the first subscription or the second subscription of the UE to perform a mode operation of the second subscription or the first subscription, respectively.

### FIELD OF THE DISCLOSURE

Aspects of the present disclosure generally relate to wireless communication and to techniques and apparatuses for subscription sharing in a multi-subscriber identity module user equipment in a dual connectivity mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies, including those applicable to other multiple access technologies and the telecommunication standards that employ these technologies.

### SUMMARY

The following summarizes some aspects of the present disclosure to provide a basic understanding of the discussed technology. This summary is not an extensive overview of all contemplated features of the disclosure and is intended neither to identify key elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects of the present disclosure disclose a method of wireless communication performed by a user equipment (UE). The method comprises detecting that a radio access technology (RAT) of a first cell on which a first subscription of the UE is configured to camp is same as the RAT of a secondary cell group (SCG) on which a second subscription of the UE that is in a dual connectivity mode is configured to camp; and triggering, in response to the detecting, the first subscription or the second subscription to perform a mode operation of the second subscription or the first subscription, respectively.

Some aspects of the present disclosure disclose a user equipment (UE) comprising a processor configured to detect that a radio access technology (RAT) of a first cell on which a first subscription of the UE is configured to camp is same as the RAT of a secondary cell group (SCG) on which a second subscription of the UE that is in a dual connectivity mode is configured to camp; and trigger, in response to the detecting, the first subscription or the second subscription to perform a mode operation of the second subscription or the first subscription, respectively.

Some aspects of the present disclosure disclose a non-transitory computer-readable medium (CRM) having program code recorded thereon. In some aspects, the program code comprises code for causing a user equipment (UE) to detect that a radio access technology (RAT) of a first cell on which a first subscription of the UE is configured to camp is same as the RAT of a secondary cell group (SCG) on which a second subscription of the UE that is in a dual connectivity mode is configured to camp; and code for causing the UE to trigger, in response to the detecting, the first subscription or the second subscription to perform a mode operation of the second subscription or the first subscription, respectively.

Some aspects of the present disclosure disclose a user equipment (UE), comprising: means for detecting that a radio access technology (RAT) of a first cell on which a first subscription of the UE is configured to camp is same as the RAT of a secondary cell group (SCG) on which a second subscription of the UE that is in a dual connectivity mode is configured to camp; and means for triggering, in response to the detecting, the first subscription or the second subscription to perform a mode operation of the second subscription or the first subscription, respectively.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with various aspects of the present disclosure.

FIG. 2 is a diagram illustrating an example of a base station in communication with a UE in a wireless communication network, in accordance with various aspects of the present disclosure.

FIG. 3 is a diagram illustrating an example of operations of a multi-subscriber identity module user equipment, in accordance with various aspects of the present disclosure.

FIG. 4 is a diagram illustrating multi-subscriber identification module (MSIM) subscription sharing in a user equipment (UE) in dual connectivity mode, in accordance with various aspects of the present disclosure.

FIG. 5 is a block diagram of an exemplary UE according to some aspects of the present disclosure.

FIG. 6 is a block diagram of an exemplary base station (BS) according to some aspects of the present disclosure.

FIG. 7 is a diagram illustrating an example process performed by a user equipment, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

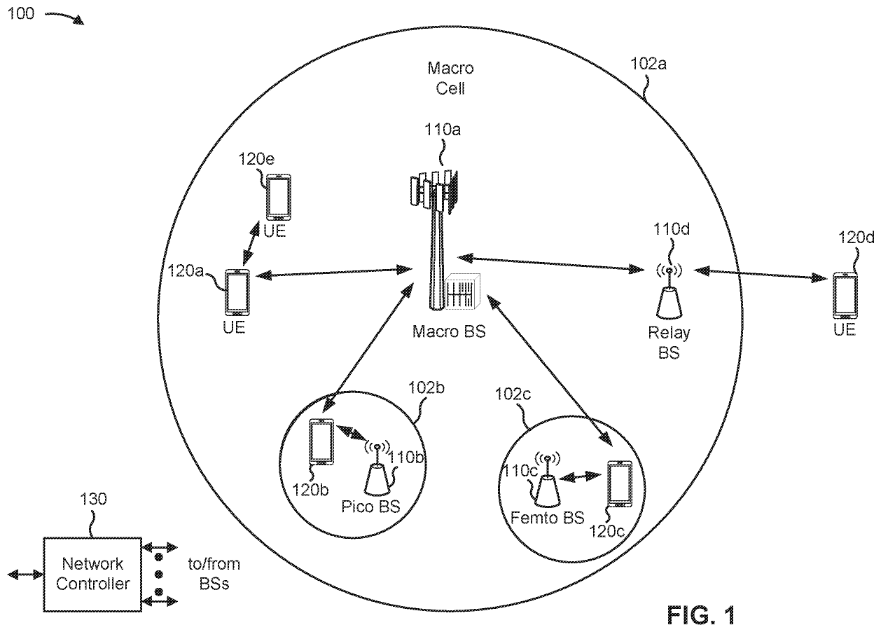

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. In some instances, the terms “eNB”, “base station”, “NR BS”, “gNB”, “TRP”, “AP”, “node B”, “5G NB”, and “cell” may be used interchangeably herein. In some instances, the term “eNB” may refer to LTE nodes or base stations, and the terms “NR BS”, “gNB”, and “5G NB” may refer to NR nodes or base stations.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. In some aspects, a UE 120 may be a multi-SIM UE that includes two or more SIMs.

Some UEs may be considered machine-type communication (MTC) or evolved or enhanced machine-type communication (eMTC) UEs. MTC and eMTC UEs include, for example, robots, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, LTE RAT networks may be deployed. In some cases, NR or 5G RAT networks may be deployed. In some instances, a NR RAT network may be deployed in so-called standalone (SA) mode or non-standalone (NSA) mode. In SA mode, the wireless network may only include NR RAT, i.e., for example, the wireless network may only include NR or 5G Node B (gNB) base stations and the 5G NR base stations are used for both control plane functionality and data plane communication. In NSA mode, the wireless network may include both LTE enhanced node (eNB) base stations as well as NR gNB base stations, and the LTE base stations may be used for control plane functionality and the 5G NR base stations may be used for data plane communication. In some cases, the LTE eNBs may serve as master nodes (e.g., make up the master cell group (MCG) of the wireless network) and the NR gNBs may serve as secondary nodes (e.g., make up the secondary cell group (SCG) of the wireless network). That is, the MCG may be LTE MCG and the SCG may be NR/5G SCG.

In some instances, a UE may run in NSA mode, where the UE may communicate to both a LTE BS and a 5G NR BS. The UE may use the LTE BS for control plane functionality, and the 5G NR BS for data plane communication. Where service providers have enabled the wireless network to function with NSA operation, the core network utilizes aspect of each BS to facilitate communication with the UE. In order to initiate NSA operation, the UE attaches to the LTE BS and signals that it supports dual connectivity (DC) operation. The LTE and 5G BSs then communicate to establish data communication via the 5G NR BS and control information communication via the LTE BS.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

In some aspects, the network 100 may be an 5G NR network deployed over a licensed spectrum. The BSs 110 can transmit synchronization signals (e.g., including a primary synchronization signal (PSS) and a secondary synchronization signal (SSS)) in the network 100 to facilitate synchronization. The BSs 110 can broadcast system information associated with the network 100 (e.g., including a master information block (MIB), remaining system information (RMSI), and other system information (OSI)) to facilitate initial network access. In some instances, the BSs 110 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some instances, a UE 120 attempting to access the network 100 may perform an initial cell search by detecting a primary synchronization signal (PSS) from a BS 110. The PSS may enable synchronization of period timing and may indicate a sector identity value (e.g., 0, 1, 2, etc.). The UE 120 may then receive a secondary synchronization signal (SSS). The SSS may enable radio frame synchronization, and may provide a cell identity value, which may be combined with the PSS identity value to identify the physical cell identity. The SSS may also enable detection of a duplexing mode and a cyclic prefix length. Both the PSS and the SSS may be located in a central portion of a carrier, respectively. After receiving the PSS and SSS, the UE 120 may receive a master information block (MIB), which may be transmitted in the physical broadcast channel (PBCH). The MIB may contain system bandwidth information, a system frame number (SFN), and a Physical Hybrid-ARQ Indicator Channel (PHICH) configuration. After decoding the MIB, the UE 120 may receive one or more system information blocks (SIBs). For example, SIB1 may contain cell access parameters and scheduling information for other SIBs. Decoding SIB1 may enable the UE 120 to receive SIB2. SIB2 may contain radio resource configuration (RRC) configuration information related to random access channel (RACH) procedures, paging, physical uplink control channel (PUCCH), physical uplink shared channel (PUSCH), power control, SRS, and cell barring. After obtaining the MIB and/or the SIBs, the UE 120 can perform random access procedures to establish a connection with the BS 110.

After establishing the connection, the UE 120 and the BS 110 can enter a normal operation stage, where operational data may be exchanged. For example, the BS 110 may schedule the UE 120 for UL and/or DL communications. The BS 110 may transmit UL and/or DL scheduling grants to the UE 120 via a PDCCH. The scheduling grants may be transmitted in the form of DL control information (DCI). The BS 110 may transmit a DL communication signal (e.g., carrying data) to the UE 120 via a PDSCH according to a DL scheduling grant. The UE 120 may transmit a UL communication signal to the BS 110 via a PUSCH and/or PUCCH according to a UL scheduling grant.

As indicated above, FIG. 1 is provided as an example. Other examples may differ from what is described with regard to FIG. 1.

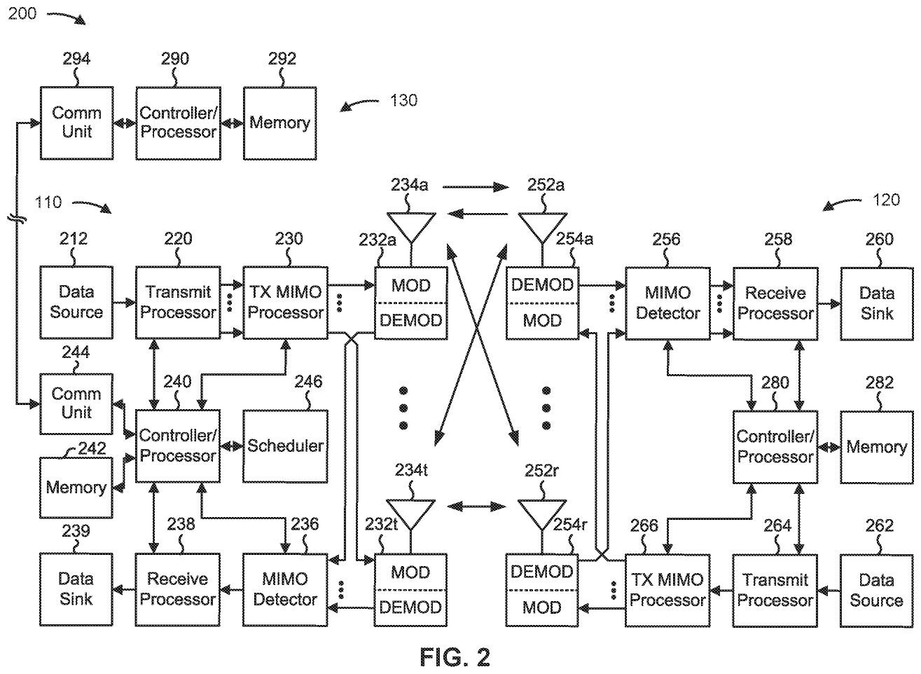

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

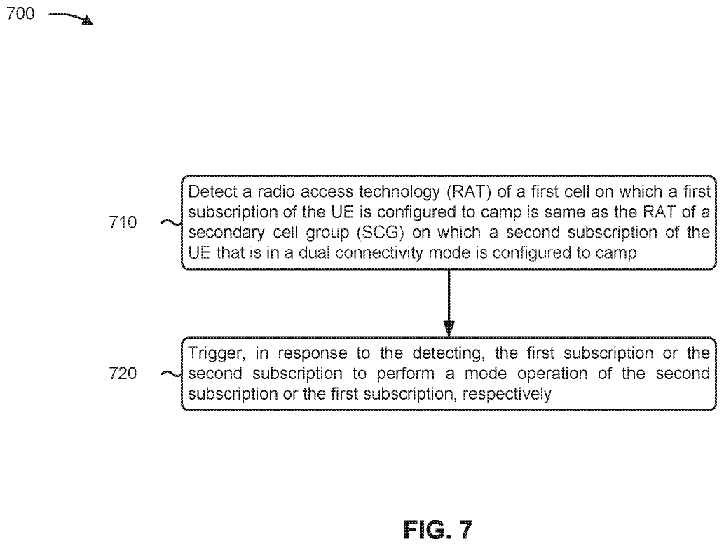

Controller/processor 240 of base station 110, controller/processor 280 of UE 120, and/or any other component(s) of FIG. 2 may perform one or more techniques associated with subscription sharing in a multi-subscriber identity module (MSIM) UE in a dual connectivity mode, as described in more detail elsewhere herein. For example, controller/processor 240 of base station 110, controller/processor 280 of UE 120, and/or any other component(s) of FIG. 2 may perform or direct operations of, for example, process 800 of FIG. 8 and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 700 of FIG. 7 and/or other processes as described herein. A scheduler 246 may schedule UEs for data transmission on the downlink and/or uplink.

In some aspects, UE 120 may include means for detecting a radio access technology (RAT) of a first cell on which a first subscription of the UE is configured to camp is same as the RAT of a secondary cell group (SCG) on which a second subscription of the UE that is in a dual connectivity mode is configured to camp; and means for triggering, in response to the detecting, the first subscription or the second subscription to perform a mode operation of the second subscription or the first subscription, respectively. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

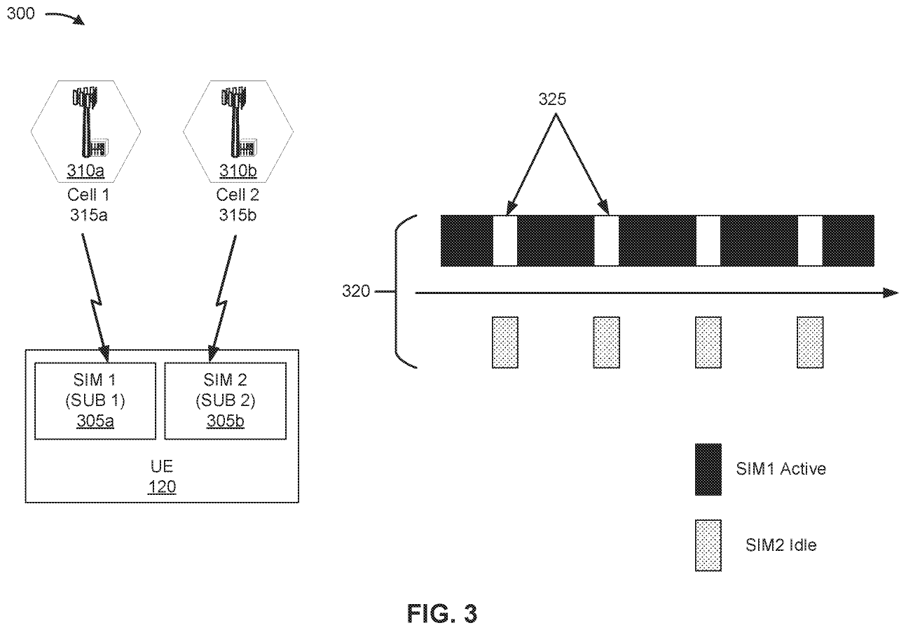

FIG. 3 is a diagram illustrating an example 300 of operations of a multi-subscriber identity module (multi-SIM) UE, in accordance with various aspects of the present disclosure. As shown in FIG. 3, a UE 120 may be a multi-SIM UE that includes multiple SIMs (e.g., two or more SIMs), shown as a first SIM 305a (shown as SIM 1) and a second SIM 305b (shown as SIM 2). The first SIM 305a may be associated with a first subscription (shown as SUB 1), and the second SIM 305b may be associated with a second subscription (shown as SUB 2). “Subscription” may refer to a subscription with a network operator (e.g., a mobile network operator (MNO)) that permits the UE 120 to access a wireless network (e.g., a radio access network (RAN)) associated with the network operator. A SIM 305 may be a removable SIM (e.g., a SIM card) or an embedded SIM. A SIM 305 may include an integrated circuit that securely stores an international mobile subscriber identity (IMSI) and a security key, which are used to identify and authenticate a corresponding subscription associated with the SIM 305. In some cases, a SIM 305 may store a list of services that the UE 120 has permission to access using a subscription associated with the SIM 305, such as a data service, a voice service, and/or the like.

As further shown in FIG. 3, the UE 120 may communicate (e.g., in a connected mode or an idle mode) with a first base station 310a via a first cell 315a (shown as Cell 1) using the first SIM 305a. In this case, a first subscription (SUB 1) of the UE 120 may be used to access the first cell 315a (e.g., using a first IMSI for UE identification, using a first security key for UE authentication, using a first list of services that the UE 120 is permitted to access using the first subscription, by counting data and/or voice usage on the first cell against the first subscription, and/or the like). Similarly, the UE 120 may communicate (e.g., in a connected mode or an idle mode) with a second base station 310b via a second cell 315b (shown as Cell 2) using the second SIM 305b. In this case, a second subscription (SUB 2) of the UE 120 may be used to access the second cell 315b (e.g., using a second IMSI for UE identification, using a second security key for UE authentication, using a second list of services that the UE 120 is permitted to access using the second subscription, by counting data and/or voice usage on the second cell against the second subscription, and/or the like). The first base station 310a and/or the second base station 310b may include one or more of the base stations 110 described above in connection with FIG. 1.

In some aspects, significant power savings as well as improved throughput, latency and reliability may occur in a UE as a result of subscription or page merge where one subscription in an active state or mode performs the operations of the other subscription which may be in an idle mode or connected (i.e., active) mode. For example, SUB1 of the UE 120 may be in an active mode and SUB2 of the UE 120 may be in an idle or connected state, and the operations of the UE 120 may be improved as noted above if subscription or page merge occurs and SUB1 performs operations of SUB2 such as but not limited to idle mode measurements (e.g., for cell selection/cell reselection due to UE mobility), page decoding, etc., of SUB2.

The benefits of subscription or page merge in a MSIM UE 120 may be illustrated with reference to FIG. 3, where as shown by reference number 320, if the first subscription SUB 1 using SIM 1 is in a connected mode and is transmitting or receiving data, and the second subscription SUB2 using SIM 2 is in an idle mode, then the UE 120 may periodically tune away from the first subscription SUB1 (e.g., may tune away from Cell 1) to perform idle mode operations using the second subscription SUB2 (e.g., may tune to Cell 2). For example, the UE 120 may tune to Cell 2 to monitor for paging messages (sometimes referred to as pages) and/or to perform other idle mode operations for the second subscription SUB2. As shown by reference number 325, the UE 120 may not be capable of communicating using the first subscription SUB1 while tuned to Cell 2 associated with the second subscription SUB2. As a result, the UE 120 may operate with lower throughput, higher latency, lower reliability, and/or the like for the first subscription SUB1. Furthermore, tuning between the different cells may increase power consumption and/or reduces battery life of the UE 120. Subscription or page merging, however, may avoid the noted inefficiencies and operational degradations of the first subscription SUB1. For example, the noted lower throughput, higher latency, lower reliability, etc., may be reduced or avoided because the UE may not need to tune away to the second subscription SUB2 (e.g., because the first subscription SUB1 may perform the idle operations of the second subscription SUB2). Further, there can be significant power savings because SUB2 may not be performing the measurements.

In some aspects, subscription or page merge may not occur unless the active radio access technology (RAT) associated with the first subscription SUB1, that is, the RAT of the network to which SUB1 is connected, is same as the active RAT of the second subscription SUB2. That is, in some cases, subscription or page merge may be possible only when both SUB1 and SUB2 are associated with the same active NR RAT or LTE RAT (i.e., both SUB1 and SUB2 are connected to networks having the same NR RAT or LTE RAT). For example, in some instances, if SUB1 is associated with an active NR RAT network or LTE RAT network via a 5G NR base station (e.g., gNB) or a LTE base station (e.g., enhanced NB (eNB)), respectively, then subscription or page merge may occur only when SUB2 is associated with an active NR RAT network or LTE RAT network via a gNB or an eNB also, respectively. In some instances, the term “active” Rat may refer to the RAT of the master cell group (MCG) of the wireless network.

In some aspects, one of the subscriptions of a UE may be operating in a dual connectivity (DC) mode where the subscription is capable of connecting to both LTE and NR nodes/cells and utilizing resources from both, while the other subscription is configured to connect to a LTE network or a NR network. For example, the DC mode can be a multi-radio dual connectivity (MRDC) mode such as but not limited to an evolved universal terrestrial radio access (E-UTRA)-new radio (NR) dual connectivity (ENDC) mode, NR E-UTRA DC (NEDC) mode, etc. In ENDC mode, a UE (or a subscription thereof) may connect with a LTE node which may be acting as the master node and a NR node which may be acting as a secondary node. For instance, the UE or subscription may be connecting with a LTE MCG and a NR SCG. For example, the NR RAT network to which the UE or the subscription is connected may be deployed in NSA mode where the UE or the subscription in ENDC mode may communicate to both the LTE MCG and the 5G NR SCG. In NEDC mode, a UE (or a subscription thereof) may connect with a NR node which may be acting as the master node and a LTE node which may be acting as a secondary node. For instance, the UE or subscription may be connecting with an NR MCG and a LTE SCG.

In some aspects, the aforementioned operational inefficiencies that may result due to the presence of multiple subscriptions in a MSIM UE, such as but not limited to lower throughput, higher latency, lower reliability, etc., may also occur when a subscription of a UE operates in a DC mode. For example, if a first subscription of a UE is connected to a node or cell associated with a NR RAT and the second subscription is operating in an ENDC mode communicating with a LTE MCG and NR SCG, the UE may tune away from the second subscription to perform the activities of the first subscription (e.g., idle mode measurements for cell selection/cell reselection due to UE mobility and page decoding, etc.). Another example is when a first subscription of a UE is connected to a node or cell associated with a LTE RAT and the second subscription is operating in an NEDC mode communicating with a NR MCG and LTE SCG. In such cases, the UE may tune away from the second subscription to perform the activities of the first subscription. As discussed above, the tune-away by the UE may negatively affect the throughput, latency, reliability, etc., of the second subscription as well as significantly increase UE power consumption. As such, there is a need for mechanisms and techniques that allow a subscription or page merge between a first subscription of a UE associated with a first RAT and a second subscription of the UE operating in a DC mode where the SCG to which the second subscription is connected is associated with the same first RAT, i.e., systems and methods that allow the second subscription to perform the operations or activities (e.g., mode operations) of the first subscription. The benefits of such solutions include improved throughput, latency, reliability, etc., for the second subscription (e.g., because the UE may not tune away to the first subscription from the second subscription) as well as significant power savings (e.g., because the first subscription is not performing the mode operations or measurements).

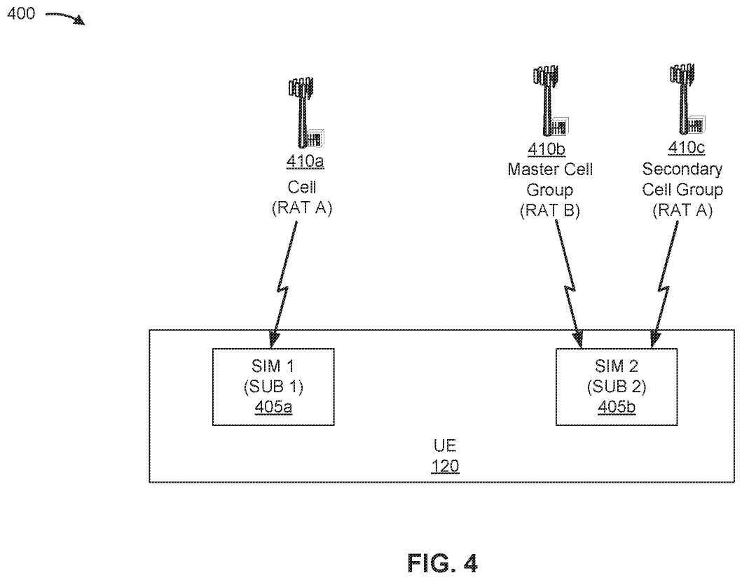

Some aspects of the present disclosure disclose methods and systems for subscription sharing in a multi-subscriber identity module (MSIM) user equipment (UE) where a subscription of the MSIM UE is in a dual connectivity mode. FIG. 4 shows an example diagram illustrating a MSIM UE 120 (e.g., having two or more SIMs) having a first SIM 405a (shown as SIM 1) associated with a first subscription SUB1 and a second SIM 2 405b (shown as SIM 2) associated with a second subscription SUB2. In some instances, the first subscription SUB 1 may be configured to camp on a cell 410a of a wireless communications network with a first RAT (labeled RAT A in FIG. 4). In some instances, the second subscription SUB 2 may be in dual connectivity (DC) mode and may be communicating with two cell groups a wireless communication network, a master cell group (MCG) 410b with a second RAT (labeled RAT B in FIG. 4) and a secondary cell group (SCG) 410c with same RAT as the first RAT (i.e., RAT A). For example, when the DC mode is an ENDC mode, RAT A may be LTE RAT and RAT B may be NR RAT. That is, SUB 1 may be camped on a 5G NR cell 410a and SUB 2 may be communicating with a LTE MCG and 5G NR SCG (e.g., SUB 2 may be camped on the 5G NR SCG). As another example, when the DC mode is a NEDC mode, RAT A may be 5G NR RAT and RAT B may be LTE RAT. That is, SUB 1 may be camped on a LTE cell 410a and SUB 2 may be communicating with a 5G NR MCG and LTE SCG (e.g., SUB 2 may be camped on the LTE SCG).

In some aspects, the UE 120 may detect that the RAT of cell 410a on which the first subscription SUB 1 of the UE 120 is configured to camp is same as the RAT of a secondary cell group (SCG) 410c on which the second subscription SUB 2 of the UE 120 that is in a dual connectivity mode is configured to camp. That is, the UE 120 may detect that the RAT of cell 410a, RAT A, is the same as the RAT of SCG 410c, which is also RAT A. In some instances, for example when the DC mode of the second subscription SUB 2 is ENDC or NEDC, the UE 120 may also detect that the RAT A of cell 410a (e.g., on which SUB 1 may be camped) and the SCG 410c (e.g., on which SUB 2 may be camped) is LTE RAT or 5G NR RAT, respectively.

In some aspects, upon detecting that the RAT of cell 410a is same as the RAT of the SCG 410c, the UE 120 may trigger a subscription or page merge between the first subscription SUB 1 and the second subscription SUB 2. In some instances, the UE 120 may trigger the second subscription SUB 2 to perform mode operations (e.g., idle mode operations) of the first subscription SUB 1. In some instances, the mode operations can be idle mode operations. For example, the mode operations may include measurements for cell selection/cell reselection, decoding of system information block (SIB), page decoding, etc. In some cases, SUB 1 or SUB 2 can perform the mode operations of SUB 2 or USB 1, respectively, because SUB 1 and SUB 2 may share, respectively via cell 410a and SCH 410c, a wireless network (e.g., with the RAT A).

In some aspects, the UE 120 may trigger the subscription or page merge between the first subscription SUB 1 and the second subscription SUB 2 based on one or more subscription merge triggering conditions. For example, when the DC mode of SUB 2 is ENDC mode (i.e., the SCG 410c is a 5G NR SCG), the UE 120 may trigger the subscription merge if at least one NR cell in the 5G NR SCG 410 is capable of operating in a standalone (SA) mode. That is, the UE 120 may trigger the subscription merge upon determining that at least one 5G NR cell in the 5G NR SCG 410 is configured to operate in SA mode, i.e., upon determining that that at least one 5G NR cell can be used for both control plane functionality and data plane communication for the second subscription SUB 2. In some instances, the UE 120 may determine that the at least one 5G NR cell is configured for SA mode based on MIB or SIB1 configuration of the at least one 5G NR cell.

In some instances, the 5G NR cell configuration may be received from the same cell, i.e., that at least one 5G NR cell. For example, the UE 120 may receive SIB 1 message from the at least one 5G NR cell, the SIB 1 message including 5G NR cell configuration or cell access related information such as but not limited to public land mobile network (PLMN) information, a tracking area code (TAC), a cell barring information, and/or the like, associated with the at least one 5G NR cell. In such cases, the UE 120 may read the 5G NR cell configuration or the cell access related information from SIB1 and determine whether the at least one 5G NR cell is SA mode capable or is configured for SA mode operation. Further, the UE 120 may also use the configuration or the cell access related information as suitable camping criteria for standalone mode. In some instances, in addition to or instead of receiving the 5G NR cell configuration from the 5G NR cell, the UE 120 may retrieve the same from a cell database stored in a memory of the UE 120 that is configured to store cell configurations (e.g., of cells capable of operating in the SA mode). In such cases, the UE 120 may retrieve and read the 5G NR cell configuration from the database to determine the SA mode capability of the at least one 5G NR cell.

In some aspects, for example when the DC mode of SUB 2 is ENDC mode (i.e., the SCG 410c is a 5G NR SCG), the UE 120 may trigger the subscription or page merge between the first subscription SUB 1 and the second subscription SUB 2 in response to receiving, from the at least one 5G NR cell in the SCG, a message that includes a paging control channel (PCCH) configuration. In some instances, PCCH is a downlink channel that allows the at least one 5G NR cell to page the UE 120 when the location of the UE 120 is not known to the wireless network. In some cases, the message can be a SIB 1 message and the PCCH configuration contained therein can be for a paging occasion (PO) of the second subscription SUB 2 of the UE 120. In some instances, the PO can be a bandwidth part (BWP) of a radio channel between the second subscription SUB 2 of the UE 120 and the at least one 5G NR cell in the SCG. That is, the PCCH configuration received from the at least one 5G NR cell in the SCG (e.g., via a SIB1) may include a BWP of the radio frame structure of the channel between the at least one 5G NR cell and SUB 2 of the UE 120 via which SUB 2 may receive paging messages from the at least one 5G NR cell.

In some aspects, the one or more subscription merge triggering conditions for when the DC mode of SUB 2 is ENDC mode (i.e., the MCG 410b is a LTE MCG and the SCG 410c is a 5G NR SCG) or NEDC mode (i.e., the MCG 410b is a 5G NR MCG and the SCG 410c is a LTE SCG) may include the radio conditions of the cells in the MCG 410b and/or in the SCG 410c. For example, with reference to the ENDC mode, the UE 120 may trigger the subscription merge between the first subscription SUB 1 and the second subscription SUB 2 when one or both of a cell energy of a NR cell in the SCG 410c or a cell energy of a LTE cell in the MCG 410b are greater than a respective cell energy threshold. As another example, with reference to the NEDC mode, the UE 120 may trigger the subscription merge between SUB 1 and SUB 2 when one or both of a cell energy of a LTE cell in the SCG 410c or a cell energy of a 5G NR cell in the MCG 410b are greater than a respective cell energy threshold.

In some aspects, for instance when the DC mode of SUB 2 is either ENDC mode or NEDC mode, the one or more subscription merge triggering conditions may also include whether the PLMN associated with the cell 410a on which SUB1 is camped is the same as or at least substantially equivalent to the PLMN associated with the SCG 410c (e.g., or a cell therein) on which SUB 2 is camped. For example, the UE 120 may trigger the subscription merge between the first subscription SUB 1 and the second subscription SUB 2 when a PLMN associated with the first cell 410a is configured to allow SUB 2 to camp on the first cell 410. Further, the UE 120 may trigger the subscription merge between the first subscription SUB 1 and the second subscription SUB 2 when a PLMN associated with the SCG 410c is configured to allow the first subscription SUB 1 to camp on the SCG 410c.

In some aspects, after a subscription merge occurs between SUB 1 and SUB 2, there may be a change in the configuration of one or both of SUB 1 or SUB 2 that may affect the subscription merge (e.g., make the merge impractical or no longer possible). For example, when the DC mode of SUB 2 is ENDC mode (i.e., the MCG 410b is a LTE MCG and the SCG 410c is a 5G NR SCG), the UE 120 may experience evolved packet system fallback (EPSFB) where SUB 2 may move or switch from connecting to a NR network (e.g., via the 5G NR SCG 410c) to a LTE network (e.g., via the LTE MCG 410b). In such cases, because SUB 2 is active on the LTE network and may not be merged with SUB 1 that is active on a NR network associated with cell 410a, the subscription merge between SUB 1 and SUB 2 may be evaluated and in some cases disabled. That is, in some instances, the UE 120 may detect a change in a configuration of the DC mode of SUB 2, and disable the subscription merge, i.e., disable the SUB 2 (or SUB 1) from performing the mode operation of SUB 1 (or SUB 2). In some cases, such a configuration change can be an ESPFB experienced by SUB 2. In some cases, the configuration change can be a handover of the SUB 2 from a first cell in the SCG to a different second cell, or an addition or a removal of a cell in the SCG. In such cases, the UE 120 may check to see if the second cell is SA mode capable before disabling the subscription or page merge between SUB 1 and SUB 2.

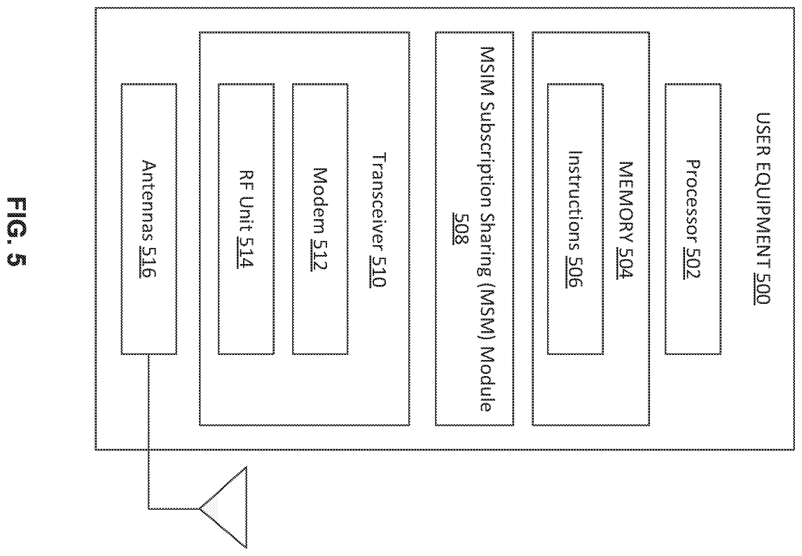

FIG. 5 is a block diagram of an exemplary UE 500 according to some aspects of the present disclosure. The UE 500 may be a UE 120 as discussed above with respect to FIGS. 1, 2, 3, and 4. As shown, the UE 500 may include a processor 502, a memory 504, a MSIM subscription sharing (MSS) module 508, a transceiver 510 including a modem subsystem 512 and a radio frequency (RF) unit 514, and one or more antennas 516. These elements may be coupled with one another. The term “coupled” may refer to directly or indirectly coupled or connected to one or more intervening elements. For instance, these elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 1-4, and 7. Instructions 506 may also be referred to as program code, which may be interpreted broadly to include any type of computer-readable statement(s). The program code may be for causing a wireless communication device to perform these operations, for example by causing one or more processors (such as processor 502) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The MSS module 508 may be implemented via hardware, software, or combinations thereof. For example, the MSS module 508 may be implemented as a processor, circuit, and/or instructions 506 stored in the memory 504 and executed by the processor 502. In some examples, the MSS module 508 can be integrated within the modem subsystem 512. For example, the MSS module 508 can be implemented by a combination of software components (e.g., executed by a DSP or a general processor) and hardware components (e.g., logic gates and circuitry) within the modem subsystem 512.

The MSS module 508 may communicate with various components of the UE 500 to perform aspects of the present disclosure, for example, aspects of FIGS. 1-4, and 7. In some aspects, the MSS module 508 is configured to detect a radio access technology (RAT) of a first cell on which a first subscription of the UE is configured to camp is same as the RAT of a secondary cell group (SCG) on which a second subscription of the UE that is in a dual connectivity mode is configured to camp. Further, the MSS module 508 is configured to trigger, in response to the detecting, the first subscription or the second subscription to perform a mode operation of the second subscription or the first subscription, respectively.

As shown, the transceiver 510 may include the modem subsystem 512 and the RF unit 514. The transceiver 510 can be configured to communicate bi-directionally with other devices, such as the BSs 110. The modem subsystem 512 may be configured to modulate and/or encode the data from the memory 504 and/or the MSS module 508 according to a modulation and coding scheme (MCS), e.g., a low-density parity check (LDPC) coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., control information (uplink and/or downlink), data (uplink and/or downlink), paging messages, etc.) from the modem subsystem 512 (on outbound transmissions) or of transmissions originating from another source such as a UE 120 or a BS 110. The RF unit 514 may be further configured to perform analog beamforming in conjunction with the digital beamforming. Although shown as integrated together in transceiver 510, the modem subsystem 512 and the RF unit 514 may be separate devices that are coupled together at the UE 120 to enable the UE 120 to communicate with other devices.

The RF unit 514 may provide the modulated and/or processed data, e.g. data packets (or, more generally, data messages that may include one or more data packets and other information), to the antennas 516 for transmission to one or more other devices. The antennas 516 may further receive data messages transmitted from other devices. The antennas 516 may provide the received data messages for processing and/or demodulation at the transceiver 510. The transceiver 510 may provide the demodulated and decoded data (e.g., control information (uplink and/or downlink), data (uplink and/or downlink), paging messages, etc.) to the MSS module 508 for processing. The antennas 516 may include multiple antennas of similar or different designs in order to sustain multiple transmission links. The RF unit 514 may configure the antennas 516.

In an aspect, the UE 500 can include multiple transceivers 510 implementing different RATs (e.g., NR and LTE). In an aspect, the UE 500 can include a single transceiver 510 implementing multiple RATs (e.g., NR and LTE). In an aspect, the transceiver 510 can include various components, where different combinations of components can implement different RATs.

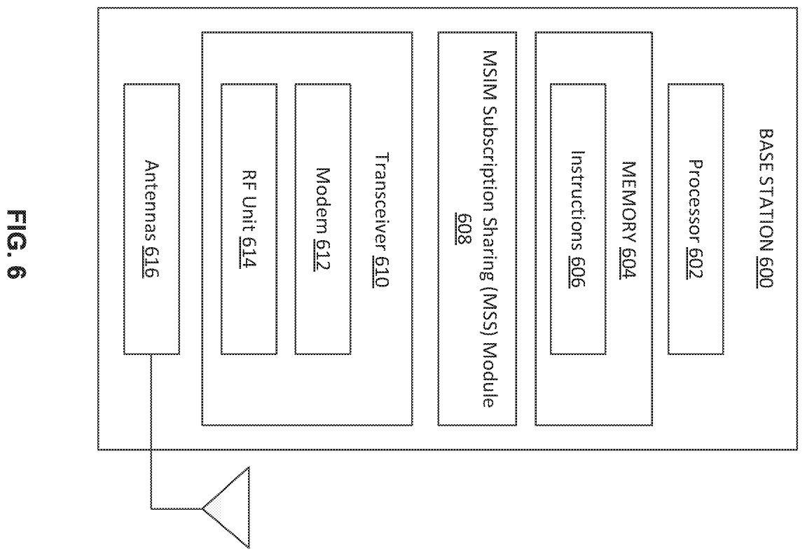

FIG. 6 is a block diagram of an exemplary BS 600 according to some aspects of the present disclosure. The BS 600 may be a BS 110 in the network 100 as discussed above in FIG. 1, or 2, a BS 310 as discussed above in FIG. 3, or a BS 410 as discussed above in FIG. 4. A shown, the BS 600 may include a processor 602, a memory 604, a MSS module 608, a transceiver 610 including a modem subsystem 612 and a RF unit 614, and one or more antennas 616. These elements may be coupled with one another. The term “coupled” may refer to directly or indirectly coupled or connected to one or more intervening elements. For instance, these elements may be in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein, for example, aspects of aspects of FIGS. 1-4, and 7. Instructions 1006 may also be referred to as program code, which may be interpreted broadly to include any type of computer-readable statement(s).

The MSS module 608 may be implemented via hardware, software, or combinations thereof. For example, the MSS module 608 may be implemented as a processor, circuit, and/or instructions 606 stored in the memory 604 and executed by the processor 602. In some examples, the MSS module 608 can be integrated within the modem subsystem 612. For example, the MSS module 608 can be implemented by a combination of software components (e.g., executed by a DSP or a general processor) and hardware components (e.g., logic gates and circuitry) within the modem subsystem 612.

The MSS module 608 may communicate with various components of the BS 600 to perform various aspects of the present disclosure, for example, aspects of FIGS. 1-4, and 7. For example, the MSS module 608 is configured to transmit paging messages to the UE 500.

As shown, the transceiver 610 may include the modem subsystem 612 and the RF unit 614. The transceiver 610 can be configured to communicate bi-directionally with other devices, such as the UEs 120 and/or another core network element. The modem subsystem 612 may be configured to modulate and/or encode data according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., RRC configuration, sidelink resource pools configurations) from the modem subsystem 612 (on outbound transmissions) or of transmissions originating from another source such as a UE 120. The RF unit 614 may be further configured to perform analog beamforming in conjunction with the digital beamforming. Although shown as integrated together in transceiver 610, the modem subsystem 612 and/or the RF unit 614 may be separate devices that are coupled together at the BS 110 to enable the BS 110 to communicate with other devices.

The RF unit 614 may provide the modulated and/or processed data, e.g. data packets (or, more generally, data messages that may contain one or more data packets and other information), to the antennas 616 for transmission to one or more other devices. This may include, for example, transmission of information to complete attachment to a network and communication with a camped UE 120 according to some aspects of the present disclosure. The antennas 616 may further receive data messages transmitted from other devices and provide the received data messages for processing and/or demodulation at the transceiver 610. The transceiver 610 may provide the demodulated and decoded data to the MSS module 608 for processing. The antennas 616 may include multiple antennas of similar or different designs in order to sustain multiple transmission links.

In an aspect, the BS 600 can include multiple transceivers 610 implementing different RATs (e.g., NR and LTE). In an aspect, the BS 600 can include a single transceiver 610 implementing multiple RATs (e.g., NR and LTE). In an aspect, the transceiver 610 can include various components, where different combinations of components can implement different RATs.

FIG. 7 is a flow diagram of a method 700 according to some aspects of the present disclosure. Aspects of the method 700 can be executed by a computing device (e.g., a processor, processing circuit, and/or other suitable component) of a wireless communication device or other suitable means for performing the steps. For example, a wireless communication device, such as the UEs 120, may utilize one or more components, such as the processor 502, the memory 504, the MSS module 508, the transceiver 510, the modem 512, and the one or more antennas 516, to execute the steps of method 700. The method 700 may employ similar mechanisms as described above in FIGS. 1-6. As illustrated, the method 700 includes a number of enumerated steps, but aspects of the method 700 may include additional steps before, after, and in between the enumerated steps. In some aspects, one or more of the enumerated steps may be omitted or performed in a different order.

At block 710, in some aspects, a UE (e.g., the UE 120) detects a radio access technology (RAT) of a first cell on which a first subscription of the UE is configured to camp is same as the RAT of a secondary cell group (SCG) on which a second subscription of the UE that is in a dual connectivity mode is configured to camp.

At block 720, in some aspects, the UE triggers, in response to the detecting, the first subscription or the second subscription to perform a mode operation of the second subscription or the first subscription, respectively.

In some aspects of method 700, the dual connectivity mode is an evolved universal terrestrial radio access (E-UTRA)-new radio (NR) dual connectivity (ENDC) mode and the RAT is a NR RAT. In such cases, the triggering occurs in further response to determining that at least one NR cell in the SCG is capable of operating in a standalone (SA) mode. Further, the determining can be based on a cell configuration indicating that the at least one NR cell in the SCG is capable of operating in the SA mode. In some instances, method 700 may further comprise retrieving the cell configuration from a cell database stored in a memory of the UE that is configured to store cell configurations of cells capable of operating in the SA mode. In some instances, method 700 may further comprise receiving, from the at least one NR cell, a system information block type 1 (SIB 1) message including the cell configuration. In some cases, the cell configuration includes a public land mobile network (PLMN) information, a tracking area code (TAC), or a cell barring information, associated with the at least one NR cell.

In some instances, the triggering occurs in further response to receiving, from a NR cell in the SCG, a message including a paging control channel (PCCH) configuration. In some cases, the message is a system information block type 1 (SIB 1) message and the PCCH configuration is for a paging occasion (PO) of the second subscription. Further, the PO is a bandwidth part (BWP) of a radio channel between the second subscription of the UE and the NR cell in the SCG. In some instances, a cell energy of a NR cell in the SCG or a cell energy of a long-term evolution (LTE) cell in a master cell group (MCG) on which the second subscription is configured to camp can be greater than a respective cell energy threshold.

In some aspects of method 700, the dual connectivity mode is a new radio (NR)-evolved-universal terrestrial radio access (E-UTRA) dual connectivity (NEDC) mode and the RAT is a long-term evolution (LTE) RAT. In some instances, a cell energy of a LTE cell in the SCG or a cell energy of a NR cell in a master cell group (MCG) on which the second subscription is configured to camp is greater than a respective cell energy threshold. In some instances, the triggering occurs in further response to receiving, from a LTE cell in the SCG, a message including a paging control channel (PCCH) configuration. Further, the message can be a system information block type 1 (SIB 1) message and the configuration is for a paging occasion (PO) of the second subscription.

In some aspects, the mode operation includes a measurement for cell selection or reselection. Some aspects of method 700 further comprise detecting a change in a configuration of the dual connectivity mode of the second subscription of the UE; and disabling the first subscription or the second subscription from performing the mode operation of the second subscription or the first subscription, respectively, in response to the change in the configuration. In some instances, the change in the configuration includes a handover of the second subscription from the SCG to a different cell, or an addition or a removal of a cell in the SCG.

In some instances, a PLMN associated with the first cell or the SCG may be configured to allow the second subscription or the first subscription to camp on the first cell or the SCG, respectively.

### RECITATIONS OF SOME ASPECTS OF THE PRESENT DISCLOSURE

Aspect 1: A method of wireless communication performed by a user equipment (UE), the method comprising: detecting a radio access technology (RAT) of a first cell on which a first subscription of the UE is configured to camp is same as the RAT of a secondary cell group (SCG) on which a second subscription of the UE that is in a dual connectivity mode is configured to camp; and triggering, in response to the detecting, the first subscription or the second subscription to perform a mode operation of the second subscription or the first subscription, respectively.

Aspect 2: The method of aspect 1, wherein the dual connectivity mode is an evolved universal terrestrial radio access (E-UTRA)-new radio (NR) dual connectivity (ENDC) mode and the RAT is a NR RAT.

Aspect 3: The method of aspect 1 or 2, wherein the triggering occurs in further response to determining that at least one NR cell in the SCG is capable of operating in a standalone (SA) mode.

Aspect 4: The method of aspect 3, wherein the determining is based on a cell configuration indicating that the at least one NR cell in the SCG is capable of operating in the SA mode.

Aspect 5: The method of aspect 4, further comprising retrieving the cell configuration from a cell database stored in a memory of the UE that is configured to store cell configurations of cells capable of operating in the SA mode.

Aspect 6: The method of aspect 4 or 5, further comprising receiving, from the at least one NR cell, a system information block type 1 (SIB 1) message including the cell configuration.

Aspect 7: The method of any of aspects 4-6, wherein the cell configuration includes a public land mobile network (PLMN) information, a tracking area code (TAC), or a cell barring information, associated with the at least one NR cell.

Aspect 8: The method of any of aspects 1-7, wherein the triggering occurs in further response to receiving, from a NR cell in the SCG, a message including a paging control channel (PCCH) configuration.

Aspect 9: The method of aspect 8, wherein the message is a system information block type 1 (SIB 1) message and the PCCH configuration is for a paging occasion (PO) of the second subscription.

Aspect 10: The method of aspect 9, wherein the PO is a bandwidth part (BWP) of a radio channel between the second subscription of the UE and the NR cell in the SCG.

Aspect 11: The method of any of aspects 1-10, wherein a cell energy of a NR cell in the SCG or a cell energy of a long-term evolution (LTE) cell in a master cell group (MCG) on which the second subscription is configured to camp is greater than a respective cell energy threshold.

Aspect 12: The method of any of aspects 1-11, wherein the dual connectivity mode is a new radio (NR)-evolved-universal terrestrial radio access (E-UTRA) dual connectivity (NEDC) mode and the RAT is a long-term evolution (LTE) RAT.

Aspect 13: The method of any of aspects 1-12, wherein a cell energy of a LTE cell in the SCG or a cell energy of a NR cell in a master cell group (MCG) on which the second subscription is configured to camp is greater than a respective cell energy threshold.

Aspect 14: The method of any of aspects 1-13, wherein the triggering occurs in further response to receiving, from a LTE cell in the SCG, a message including a paging control channel (PCCH) configuration.

Aspect 15: The method of aspect 14, wherein the message is a system information block type 1 (SIB 1) message and the configuration is for a paging occasion (PO) of the second subscription.

Aspect 16: The method of any of aspects 1-15, wherein the mode operation includes a measurement for cell selection or reselection.

Aspect 17: The method of any of aspects 1-16, further comprising: detecting a change in a configuration of the dual connectivity mode of the second subscription of the UE; and disabling the first subscription or the second subscription from performing the mode operation of the second subscription or the first subscription, respectively, in response to the change in the configuration.

Aspect 18: The method of aspect 17, wherein the change in the configuration includes a handover of the second subscription from the SCG to a different cell, or an addition or a removal of a cell in the SCG.

Aspect 19: The method of any of aspects 1-18, wherein a PLMN associated with the first cell or the SCG is configured to allow the second subscription or the first subscription to camp on the first cell or the SCG, respectively.

Aspect 20: A user equipment (UE), comprising: a memory; and a processor coupled to the memory, the UE configured to perform the methods of aspects 1-19.

Aspect 21: A non-transitory computer-readable medium (CRM) having program code recorded thereon, the program code comprises code for causing a UE to perform the methods of aspects 1-19.

Aspect 22: A user equipment (UE) comprising means for performing the methods of aspects 1-19.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), the method comprising:
detecting a radio access technology (RAT) of a first cell on which a first subscription of the UE is configured to camp is same as the RAT of a secondary cell group (SCG) on which a second subscription of the UE that is in a dual connectivity mode is configured to camp; and
triggering, in response to the detecting, the first subscription or the second subscription to perform a mode operation of the second subscription or the first subscription, respectively.

2. The method of claim 1, wherein the dual connectivity mode is an evolved universal terrestrial radio access (E-UTRA)-new radio (NR) dual connectivity (ENDC) mode and the RAT is a NR RAT.

3. The method of claim 2, wherein the triggering occurs in further response to determining that at least one NR cell in the SCG is capable of operating in a standalone (SA) mode.

4. The method of claim 3, wherein the determining is based on a cell configuration indicating that the at least one NR cell in the SCG is capable of operating in the SA mode.

5. The method of claim 4, further comprising retrieving the cell configuration from a cell database stored in a memory of the UE that is configured to store cell configurations of cells capable of operating in the SA mode.

6. The method of claim 4, further comprising receiving, from the at least one NR cell, a system information block type 1 (SIB 1) message including the cell configuration.

7. The method of claim 4, wherein the cell configuration includes a public land mobile network (PLMN) information, a tracking area code (TAC), or a cell barring information, associated with the at least one NR cell.

8. The method of claim 2, wherein the triggering occurs in further response to receiving, from a NR cell in the SCG, a message including a paging control channel (PCCH) configuration.

9. The method of claim 8, wherein the message is a system information block type 1 (SIB 1) message and the PCCH configuration is for a paging occasion (PO) of the second subscription.

10. The method of claim 9, wherein the PO is a bandwidth part (BWP) of a radio channel between the second subscription of the UE and the NR cell in the SCG.

11. The method of claim 2, wherein a cell energy of a NR cell in the SCG or a cell energy of a long-term evolution (LTE) cell in a master cell group (MCG) on which the second subscription is configured to camp is greater than a respective cell energy threshold.

12. The method of claim 1, wherein the dual connectivity mode is a new radio (NR)-evolved-universal terrestrial radio access (E-UTRA) dual connectivity (NEDC) mode and the RAT is a long-term evolution (LTE) RAT.

13. The method of claim 12, wherein a cell energy of a LTE cell in the SCG or a cell energy of a NR cell in a master cell group (MCG) on which the second subscription is configured to camp is greater than a respective cell energy threshold.

14. The method of claim 12, wherein the triggering occurs in further response to receiving, from a LTE cell in the SCG, a message including a paging control channel (PCCH) configuration.

15. The method of claim 14, wherein the message is a system information block type 1 (SIB 1) message and the configuration is for a paging occasion (PO) of the second subscription.

16. The method of claim 1, wherein the mode operation includes a measurement for cell selection or reselection.

17. The method of claim 1, further comprising:
detecting a change in a configuration of the dual connectivity mode of the second subscription of the UE; and
disabling the first subscription or the second subscription from performing the mode operation of the second subscription or the first subscription, respectively, in response to the change in the configuration.

18. The method of claim 17, wherein the change in the configuration includes a handover of the second subscription from the SCG to a different cell, or an addition or a removal of a cell in the SCG.

19. The method of claim 1, wherein a PLMN associated with the first cell or the SCG is configured to allow the second subscription or the first subscription to camp on the first cell or the SCG, respectively.

20. A user equipment (UE), comprising:
a memory; and
a processor operatively coupled to the memory and configured to:
detect a radio access technology (RAT) of a first cell on which a first subscription of the UE is configured to camp is same as the RAT of a secondary cell group (SCG) on which a second subscription of the UE that is in a dual connectivity mode is configured to camp; and
trigger, in response to the detecting, the first subscription or the second subscription to perform a mode operation of the second subscription or the first subscription, respectively.

21. The UE of claim 20, wherein the dual connectivity mode is an evolved universal terrestrial radio access (E-UTRA)-new radio (NR) dual connectivity (ENDC) mode and the RAT is a NR RAT.

22. The UE of claim 21, wherein at least one NR cell in the SCG is capable of operating in a standalone (SA) mode.

23. The UE of claim 20, wherein the dual connectivity mode is a new radio (NR)-evolved-universal terrestrial radio access (E-UTRA) dual connectivity (NEDC) mode and the RAT is a long-term evolution (LTE) RAT.

24. The UE of claim 23, wherein a cell energy of a LTE cell in the SCG or a cell energy of a NR cell in a master cell group (MCG) on which the second subscription is configured to camp is greater than a respective cell energy threshold.

25. The UE of claim 20, wherein the mode operation includes a measurement for cell selection or reselection.

26. The UE of claim 20, wherein the processor is further configured to:
detect a change in a configuration of the dual connectivity mode of the second subscription of the UE; and
disable the first subscription or the second subscription from performing the mode operation of the second subscription or the first subscription, respectively, in response to the change in the configuration.

27. The UE of claim 26, wherein the change in the configuration includes a handover of the second subscription from the SCG to a different cell, or an addition or a removal of a cell in the SCG.

28. The UE of claim 20, wherein a PLMN associated with the first cell or the SCG is configured to allow the second subscription or the first subscription to camp on the first cell or the SCG, respectively.

29. A non-transitory computer-readable medium (CRM) having program code recorded thereon, the program code comprising:
code for causing a user equipment (UE) to detect a radio access technology (RAT) of a first cell on which a first subscription of the UE is configured to camp is same as the RAT of a secondary cell group (SCG) on which a second subscription of the UE that is in a dual connectivity mode is configured to camp; and
code for causing the UE to trigger, in response to the detecting, the first subscription or the second subscription to perform a mode operation of the second subscription or the first subscription, respectively.

30. A user equipment (UE), comprising:
means for detecting a radio access technology (RAT) of a first cell on which a first subscription of the UE is configured to camp is same as the RAT of a secondary cell group (SCG) on which a second subscription of the UE that is in a dual connectivity mode is configured to camp; and
means for triggering, in response to the detecting, the first subscription or the second subscription to perform a mode operation of the second subscription or the first subscription, respectively.
